(19) United States
(12) Patent Application Publication
(10) Pub. No.: US 2026/0010993 A1
(43) Pub. Date: Jan. 8, 2026

(54) IMAGE HAZE REDUCTION FOR BACKLIT SCENES

(71) Applicant: Samsung Electronics Co., Ltd., Suwon-si (KR)

(72) Inventors: Soumendu Majee, McKinney, TX (US); John Seokjun Lee, Allen, TX (US); Hamid Rahim Sheikh, Allen, TX (US)

(21) Appl. No.: 18/929,130

(22) Filed: Oct. 28, 2024

Related U.S. Application Data
(60) Provisional application No. 63/667,576, filed on Jul. 3, 2024.

(51) Int. Cl. G06T 5/94; G06T 5/20; G06T 7/12; G06V 10/60

(52) U.S. Cl. CPC G06T 5/94; G06T 5/20; G06T 7/12; G06V 10/60

(57) ABSTRACT

A method includes obtaining multiple images via a multi-frame capture operation. The method also includes processing the multiple images using a multi-frame processing pipeline to generate a single frame image. The method also includes processing the multiple images to generate a backlit segmentation map that identifies regions in a scene of the single frame image that are illuminated by at least one background light source. The method also includes generating a dehazed single frame image based on modifying a local contrast of the single frame image using the backlit segmentation map.

### CROSS-REFERENCE TO RELATED APPLICATION AND PRIORITY CLAIM

This application claims priority under 35 U.S.C. § 119 (e) to U.S. Provisional Patent Application No. 63/667,576 filed on Jul. 3, 2024, which is hereby incorporated by reference in its entirety.

### TECHNICAL FIELD

This disclosure relates generally to image processing systems. More specifically, this disclosure relates to image haze reduction for backlit scenes.

### BACKGROUND

Camera imaging pipelines, especially for high-dynamic-range (HDR) imaging, often use a tone map at the end of the pipeline to compress the dynamic range to a small range for viewing on displays and/or print media. Local and global tone-map operations in the tone-map can be adjusted to improve contrast in the final output. However, camera imaging of strongly backlit scenes where there is a bright light source in the background can cause significant image quality degradation due to haze and contrast loss. This can be especially problematic for night or under-display-camera capture scenarios. Conventional tone mapping approaches do not adequately address these issues.

### SUMMARY

This disclosure relates to image haze reduction for backlit scenes.

In a first embodiment, a method includes obtaining multiple images via a multi-frame capture operation. The method also includes processing the multiple images using a multi-frame processing pipeline to generate a single frame image. The method also includes processing the multiple images to generate a backlit segmentation map that identifies regions in a scene of the single frame image that are illuminated by at least one background light source. The method also includes generating a dehazed single frame image based on modifying a local contrast of the single frame image using the backlit segmentation map.

In a second embodiment, an electronic device includes at least one processing device. The at least one processing device is configured to obtain multiple images via a multi-frame capture operation. The at least one processing device is also configured to process the multiple images using a multi-frame processing pipeline to generate a single frame image. The at least one processing device is also configured to process the multiple images to generate a backlit segmentation map that identifies regions in a scene of the single frame image that are illuminated by at least one background light source. The at least one processing device is also configured to generate a dehazed single frame image based on modifying a local contrast of the single frame image using the backlit segmentation map.

In a third embodiment, a non-transitory machine readable medium includes instructions that when executed cause at least one processor of an electronic device to obtain multiple images via a multi-frame capture operation. The non-transitory machine readable medium also includes instructions that when executed cause the at least one processor of the electronic device to process the multiple images using a multi-frame processing pipeline to generate a single frame image. The non-transitory machine readable medium also includes instructions that when executed cause the at least one processor of the electronic device to process the multiple images to generate a backlit segmentation map that identifies regions in a scene of the single frame image that are illuminated by at least one background light source. The non-transitory machine readable medium also includes instructions that when executed cause the at least one processor of the electronic device to generate a dehazed single frame image based on modifying a local contrast of the single frame image using the backlit segmentation map.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example image haze reduction process in accordance with this disclosure;

FIG. 3 illustrates an example backlit segmentation map creation process in accordance with this disclosure;

FIG. 4 illustrates an example local contrast improvement process in accordance with this disclosure;

FIG. 5 illustrates another example local contrast improvement process in accordance with this disclosure;

FIG. 6 illustrates an example semantic segmentation map creation process in accordance with this disclosure; and

FIG. 7 illustrates an example method for image haze reduction in accordance with this disclosure.

### DETAILED DESCRIPTION

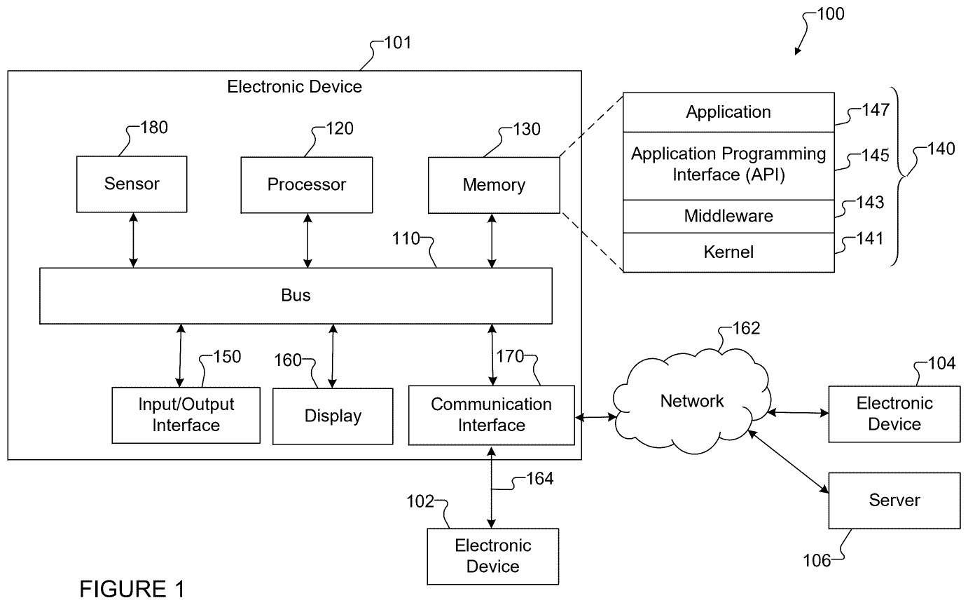

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, camera imaging pipelines, especially for high-dynamic-range (HDR) imaging, often use a tone map at the end of the pipeline to compress the dynamic range to a small range for viewing on displays and/or print media. Local and global tone-map operations in the tone-map can be adjusted to improve contrast in the final output. However, camera imaging of strongly backlit scenes where there is a bright light source in the background can cause significant image quality degradation due to haze and contrast loss. This can be especially problematic for night or under-display-camera capture scenarios. Conventional tone mapping approaches do not adequately address these issues.

Existing image processing pipelines may take multiple frames as input and perform blending, demosaicing, and denoising operations on the images. Then, a tone mapping operation may be performed to generate a final output image. As described above, these existing image processing pipelines do not adequately account for image haze and thus are prone to producing images with image quality degradation due to haze and contrast loss.

This disclosure provides systems and methods for a camera or imaging pipeline that computes a backlit segmentation map, which can also be referred to as a saturation map, from multi-frame data and uses the backlit segmentation map to adjust local contrast to remove haze due to light sources in the camera imaging. In various embodiments, the backlit segmentation map can be generated using a short frame from a multi-frame input and thresholding the short frame to determine which parts of the scene are associated with the backlight in the scene.

This disclosure also provides a local contrast improvement approach that uses the backlit segmentation map and a dark channel prior to adjust local contrast to remove haze due to light sources in the camera imaging. In various embodiments of this disclosure, the local contrast improvement can include performing a morphological refinement operation using the dark channel prior to generate a first transmission map, performing a guided filter refinement operation using the first transmission map to generate a second transmission map, and performing a radiance map generation operation using the second transmission map to generate a radiance map. A weight generation operation can be performed using the backlit segmentation map to create a dehazing strength map. To output the improved and dehazed image, a dehazing operation uses the dehazing strength map and the radiance map to create a third transmission map that is used to dehaze the input image.

In some embodiments, a semantic segmentation map can be generated that emphasizes areas in the input image relating to important subjects of the input image, such as a face (e.g., in a selfie image) and deemphasizes areas in the input image relating to less important subjects in the input image such as the sky, a ceiling, background structures and/or people, etc. The semantic segmentation map can be used together with the dehazing strength map to generate a second dehazing strength map that has had its dehazing strength weights modulated based on the areas of the image emphasized or deemphasized in the semantic segmentation map.

Images produced using the systems and methods of this disclosure have improved image quality over previous image pipelines at least because the resulting images have a less hazy or washed-out appearance, improved contrast, and improved color accuracy.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to image haze reduction in imaged scenes.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to image haze reduction in imaged scenes. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that includes one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to image haze reduction in imaged scenes.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

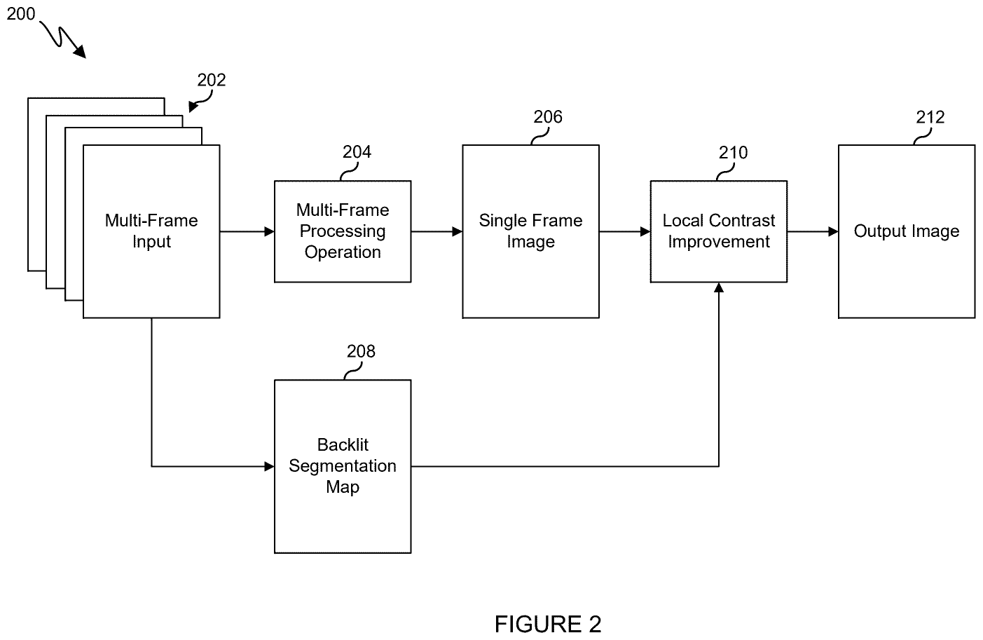

FIG. 2 illustrates an example image haze reduction process 200 in accordance with this disclosure. For case of explanation, the process 200 is described as involving the use of the electronic device 101 in the network configuration 100 of FIG. 1. However, the process 200 may be used with any other suitable electronic device (such as the server 106) or a combination of devices (such as the electronic device 101 and the server 106) and in any other suitable system(s).

As shown in FIG. 2, a multi-frame input 202 is obtained, such as by capturing the multiple image frames of a scene or environment using a camera or imaging sensor of an electronic device, such as the sensors 180 of the electronic device 101. The multi-frame input 202 is used by a multi-frame processing operation 204 to obtain a single frame image 206. Data from the multi-frame input 202 is also used to generate a backlit segmentation map 208. The backlit segmentation map 208, which can also be referred to as a saturation map, isolates backlit areas found in the multi-frame input 202. For examples, light sources or bright portions in the various frames of the multi-frame input 202 are identified, and the backlit segmentation map 208 is generated to provide a visual mapping of where the backlit areas are present in the scene.

In some embodiments, the backlit segmentation map 208 can appear as an image with the portions of the image identified as being backlit present, and possibly further brightened or shown in a white color, and with the remaining portions of the image removed or in a dark or black color, such that the backlit segmentation map 208 provides accurate locations of the light sources of the image. For example, an image of a person's face (e.g., a selfie) with a bright lit-up sign behind the person may have a backlit segmentation map 208 generated showing the bright lit-up sign in white, and other portions of the image, including the person's face, in black, to demarcate where the light sources in the image are present. It will be understood that various subjects could be included in the image, such as people, animals, objects, etc., and that various light sources may be present in the scene creating backlit environments, such as illuminated signage, lamps, hanging lights, embedded ceiling or cabinetry lights, the sun, etc.

The backlit segmentation map 208 is used by a local contrast improvement operation 210 to adjust local contrast in the single frame image 206 based on the areas in the image identified as being backlit by the backlit segmentation map 208. Adjusting the local contrast in this way removes haze effects in the single frame image 206 to provide an improved output image 212.

Although FIG. 2 illustrates one example of an image haze reduction process 200, various changes may be made to FIG. 2. For example, various components and functions in FIG. 2 may be combined, further subdivided, replicated, or rearranged according to particular needs. Also, one or more additional components and functions may be included if needed or desired.

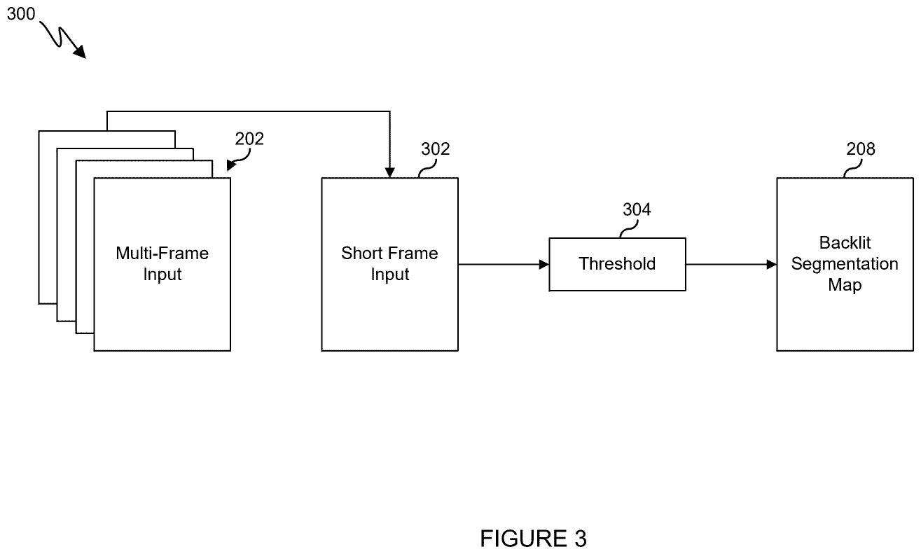

FIG. 3 illustrates an example backlit segmentation map creation process 300 in accordance with this disclosure. For case of explanation, the process 300 is described as involving the use of the electronic device 101 in the network configuration 100 of FIG. 1. However, the process 300 may be used with any other suitable electronic device (such as the server 106) or a combination of devices (such as the electronic device 101 and the server 106) and in any other suitable system(s).

As described with respect to FIG. 2, a backlit segmentation map 208 is created using data from the multi-frame input 202. As shown in FIG. 3, to create the backlit segmentation map 208, a short frame input 302 is obtained using the multi-frame input 202. In multi-frame processing pipelines, many frames are typically captured, and the captured frames can have different exposure values (EV). The multi-frame input 202 can thus include a normal frame (EVO) having an exposure value and various short frames (EV-X, where X=2, 4, 6, etc.) with each with an EV value 2\hat{ }−X of the EVO frame. The short frames assist with obtaining accurate information about the bright areas of the scene. The backlit segmentation map 208 is created by applying a threshold 304 to the short frame input 302. The backlit segmentation map 208 (M) is thus created thresholding the short frame input 302 using the threshold 304 (t₀), where M=I_{Evx}>t₀ for EV-X short frame I_{EVX} and tunable threshold t₀. The threshold 304 can be increased or decreased to consider less or more parts of the scene as the backlit areas. As described above, the backlit segmentation map can include bright regions corresponding to the backlit areas of the scene.

Although FIG. 3 illustrates one example of a backlit segmentation map creation process 300, various changes may be made to FIG. 3. For example, various components and functions in FIG. 3 may be combined, further subdivided, replicated, or rearranged according to particular needs. Also, one or more additional components and functions may be included if needed or desired.

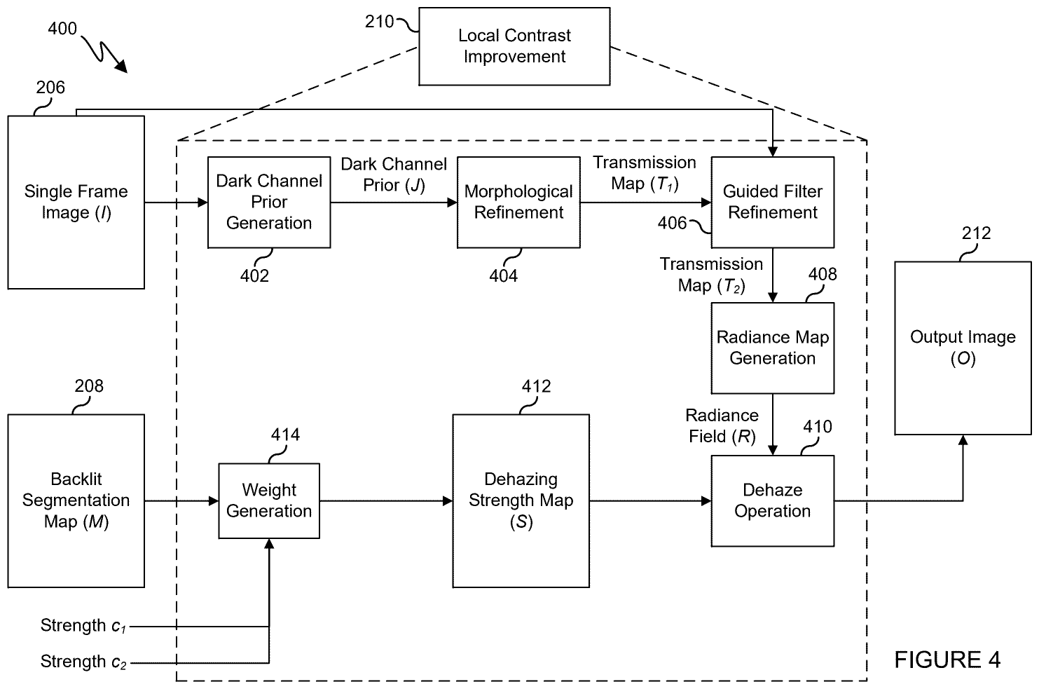

FIG. 4 illustrates an example local contrast improvement process 400 in accordance with this disclosure. For case of explanation, the process 400 is described as involving the use of the electronic device 101 in the network configuration 100 of FIG. 1. However, the process 400 may be used with any other suitable electronic device (such as the server 106) or a combination of devices (such as the electronic device 101 and the server 106) and in any other suitable system(s).

As shown in FIG. 4, the process 400 involves the use of the local contrast improvement operation 210. As described with respect to FIG. 2, the single frame image 206 and the backlit segmentation map 208 are both provided to the local contrast improvement operation 210 and the local contrast improvement operation 210 uses the backlit segmentation map 208 to improve the local contrast within the single frame image 206 to remove or reduce hazy effects in the image created by light sources in the imaged scene.

As further shown in FIG. 4, the single frame image 206 (I) is provided as input to the local contrast improvement operation 210. The local contrast improvement operation 210 includes a dark channel prior generation operation 402 that takes as input the single frame image 206 (I) and outputs a dark channel prior (J). In various embodiments, the dark channel prior generation operation 402 calculates the dark channel prior (J) based on the single frame image 206 input (I) as follows.

$$J ( x ) = {min}_{C ∈ \{ r , g , b \}} \{ {min}_{y ∈ Ω ( x )} {I}_{c} ( y ) \}$$

for input I, color channel c, and local neighborhood Ω In various embodiments, the dark channel prior image has a small value for haze free regions of the image a large value for hazy or backlight regions.

The dark channel prior (J) is provided to a morphological refinement operation 404. The morphological refinement operation 404 uses the dark channel prior image (J) to generate a first transmission map T₁. The morphological refinement operation 404 can be represented as follows.

$${T}_{1} = 1 - OP ( \frac{{J}_{d}}{a} )$$

Here “a” is the estimated atmospheric light using the top 0.1% of the dark channel of the dark channel prior image (J), and OP( ) denotes a morphological opening. In various embodiments, a small value in the transmission map signifies less of the actual scene content and more of the haze hue to bright lights is being captured at that location.

The first transmission map T₁ is provided to a guided filter refinement operation 406. The guided filter refinement operation 406 creates a refined second transmission map T₂ using the first transmission map T₁. The guided filter refinement operation 406 can be represented as follows.

T₂=1−ω*(1−GF(T₁,I)) for a tunable parameter @, and guided filter GF( ) Examples of a guided filter can be found in “He, Kaiming, Jian Sun, and Xiaoou Tang. ‘Guided image filtering.’ IEEE transactions on pattern analysis and machine intelligence 35, no. 6 (2012): 1397-1409,” which is incorporated by reference herein.

The second transmission map T₂ is provided to a radiance map generation operation 408. The radiance map generation operation 408 uses the second transmission map T₂ to generate a radiance field (or map) (R). The radiance map generation operation 408 can be represented as follows.

$$R = a + \frac{I - a}{max ( ϵ , {T}_{2} )}$$

for a tunable parameter e as outlined
Examples of estimating atmospheric light of a dark channel and of generating a radiance map based on tunable parameters can be found in “He, Kaiming, Jian Sun, and Xiaoou Tang. ‘Single image haze removal using dark channel prior.’ IEEE transactions on pattern analysis and machine intelligence 33, no. 12 (2010): 2341-2353,” which is incorporated by reference herein.

The radiance field (R) is provided to a dehazing operation 410. The dehazing operation 410 uses, the second transmission map T₂, the radiance field (R), and a dehazing strength map 412 (S) to output the improved and dehazed output image 212. The dehazing strength map 412 (S) is created using a weight generation operation 414. As shown in FIG. 4, the weight generation operation 414 takes as input the backlit segmentation map 208 (M) as well as strength values (c₁, c₂) and performs a filtering operation, such as a gaussian filtering operation, using the backlit segmentation map 208 (M) and the strength values (c₁, c₂). The weight generation operation 414 can be represented as follows.

$$S = ( 1 - H ( M ) ) * {c}_{1} + H ( M ) * {c}_{2}$$

Here, c₁, c₂, are strength values, H( ) is the gaussian filtering, and M is the backlit segmentation map 208. In some embodiments, the strength values c₁, c₂ are less than 1. For example, the strength values could be 0.1, 0.01.

The dehazing strength map 412 can be an image that includes, for example, black regions corresponding to non-backlit areas of the image, and brightened regions corresponding to backlit areas, but where no scene details are actually shown. Rather, the brightened regions can be shown as a brightened or white area in an otherwise black image, and the brightened area could be brighter in some areas then other, e.g., transitioning from white to gray to black as a brightened area transitions to a dark area. The dehazing operation 410 creates a third transmission map T₃ using the second transmission map T₂ and the dehazing strength map 412 (S), which can be represented as follows.

$${T}_{3} = min ( 1 , {T}_{2} + S )$$

The dehazing operation 410 generates the final output image 212 (O) by combining the radiance field (R) with the third transmission map T₃ via pointwise multiplication and adding to that combination a combination (via pointwise multiplication) of the estimated atmospheric light (a) and the third transmission map T₃ subtracted from a scalar (1), which can be represented as follows.

$$O = R * {T}_{3} + a * ( 1 - {T}_{3} )$$

It will be understood that, where used, upper case variables in the above equations are images, lower can variables are scalars, and * indicates pointwise multiplication for images. As shown in FIG. 4, in various embodiments, the local contrast improvement operation 210 can include all of the dark channel prior generation operation 402, the morphological refinement operation 404, the guided filter refinement operation 406, the radiance map generation operation 408, the weight generation operation 414, and the dehaze operation 410.

Although FIG. 4 illustrates one example of a local contrast improvement process 400, various changes may be made to FIG. 4. For example, various components and functions in FIG. 4 may be combined, further subdivided, replicated, or rearranged according to particular needs. Also, one or more additional components and functions may be included if needed or desired.

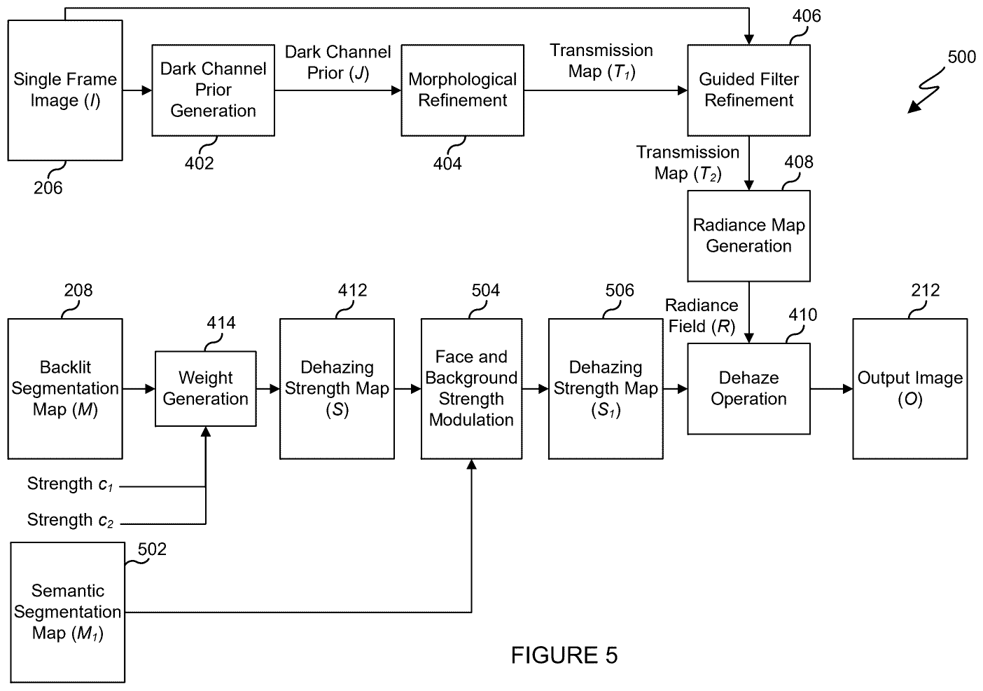

FIG. 5 illustrates another example local contrast improvement process 500 in accordance with this disclosure. For case of explanation, the process 500 is described as involving the use of the electronic device 101 in the network configuration 100 of FIG. 1. However, the process 500 may be used with any other suitable electronic device (such as the server 106) or a combination of devices (such as the electronic device 101 and the server 106) and in any other suitable system(s).

The process 500 is similar to the process 400, and can include as part of the local contrast improvement operation 210, the dark channel prior generation operation 402, the morphological refinement operation 404, the guided filter refinement operation 406, the radiance map generation operation 408, the weight generation operation 414, and the dehaze operation 410. The process 500 further includes using a semantic segmentation map 502 (M₁) to modulate the dehazing strength of the dehazing strength map 412 (S). The semantic segmentation map 502 can be an image that emphasizes areas in the input image relating to important subjects of the input image, such as a face (e.g., in a selfie image) and deemphasizes areas in the input image relating to less important subjects in the input image such as the sky, a ceiling, background structures and/or people, etc. For example, the semantic segmentation map 502 can indicate object classifications (person, face, building, sky, background people etc.) via highlighting the different classes in different colors. The semantic segmentation map 502 and the dehazing strength map 412 (S) are provided to a face and background strength modulation operation 504. The face and background strength modulation operation 504 generates a second dehazing strength map 506 (S₁) that has had its dehazing strength weights modulated based on the areas of the image emphasized or deemphasized in the semantic segmentation map 502. Modulating the dehazing strength map 412 (S) by the face and background strength modulation operation 504 to generate the second dehazing strength map 506 (S₁) can be represented as follows.

$${S}_{1} ( x ) = S ( x ) * F ( {M}_{1} ( x ) )$$

Here, M₁ is the semantic segmentation map and F( ) is a strength dictionary to store strengths for each semantic class. The strengths for each semantic class are tuning parameters chosen to balance contrast and brightness in conjunction with other parts of tone mapping.

Modulation of the dehazing strength via the semantic segmentation map 502 allows for increasing the strength for subject areas of the image, such as a face in a selfie image, which are more important for the final image quality, and allows for decreasing strength for other areas of image, such as the sky, a ceiling, background objects, etc., where too much dehazing strength can cause more image artifacts.

The dehaze operation 410, in the process 500, uses the second dehazing strength map 506 (S₁) in place of the dehazing strength map 412 to generate the third transmission map T₃, and then generates the final output image (O) using the radiance field (R) and the third transmission map T₃, which can be represented as follows.

$${T}_{3} = min ( 1 , {T}_{2} + {S}_{1} )$$

$$O = R * {T}_{3} + a * ( 1 - {T}_{3} )$$

Although FIG. 5 illustrates another example of a local contrast improvement process 500, various changes may be made to FIG. 5. For example, various components and functions in FIG. 5 may be combined, further subdivided, replicated, or rearranged according to particular needs. Also, one or more additional components and functions may be included if needed or desired.

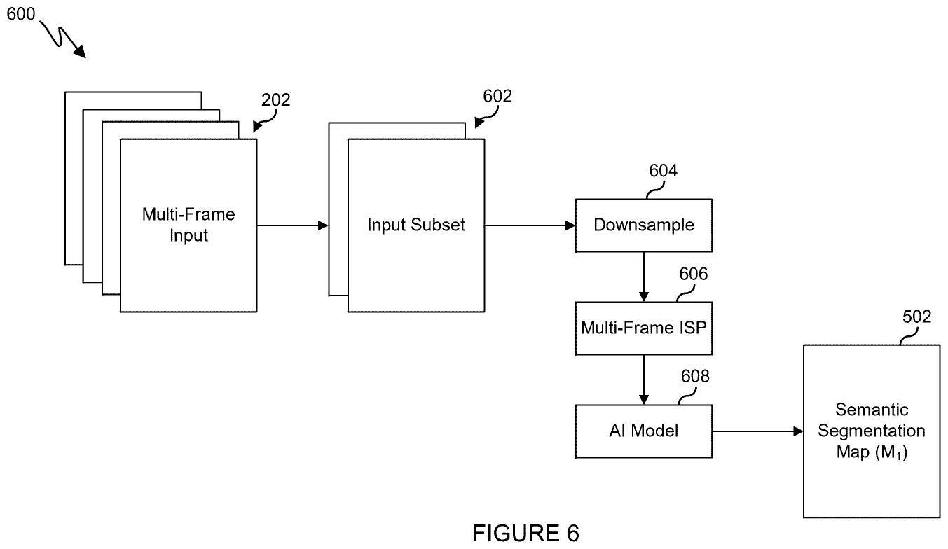

FIG. 6 illustrates an example semantic segmentation map creation process 600 in accordance with this disclosure. For ease of explanation, the process 600 is described as involving the use of the electronic device 101 in the network configuration 100 of FIG. 1. However, the process 600 may be used with any other suitable electronic device (such as the server 106) or a combination of devices (such as the electronic device 101 and the server 106) and in any other suitable system(s).

To generate the semantic segmentation map 502 (M₁), an input subset 602 can be created using the multi-frame input 202. For example, the input subset 602 could include an image having a lowest exposure value and an image having a highest exposure value of the multi-frame input 202. The input subset 602 is downsampled using a downsampling operation 604, and the downsampled image subset is then processed by a multi-frame image signal processing (ISP) operation 606.

The output(s) from the multi-frame ISP operation 606 are provided to an artificial intelligence (AI) model 608. In various embodiments of this disclosure, the AI model 608 can be a light-weight, mobile-device-friendly, AI model operating on the multi-frame ISP processed input. An example light-weight AI model could be a light-weight vision transformer, examples of which can be found in “Zhang, Wenqiang, Zilong Huang, Guozhong Luo, Tao Chen, Xinggang Wang, Wenyu Liu, Gang Yu, and Chunhua Shen. ‘Topformer: Token pyramid transformer for mobile semantic segmentation.’ In Proceedings of the IEEE/CVF Conference on Computer Vision and Pattern Recognition, pp. 12083-12093. 2022,” which is incorporated by reference herein. The semantic segmentation map classifies each pixel into various semantic classes (e.g., human, face, sky, tree, building etc.).

Although FIG. 6 illustrates another example of a semantic segmentation map creation process 600, various changes may be made to FIG. 6. For example, various components and functions in FIG. 6 may be combined, further subdivided, replicated, or rearranged according to particular needs. Also, one or more additional components and functions may be included if needed or desired.

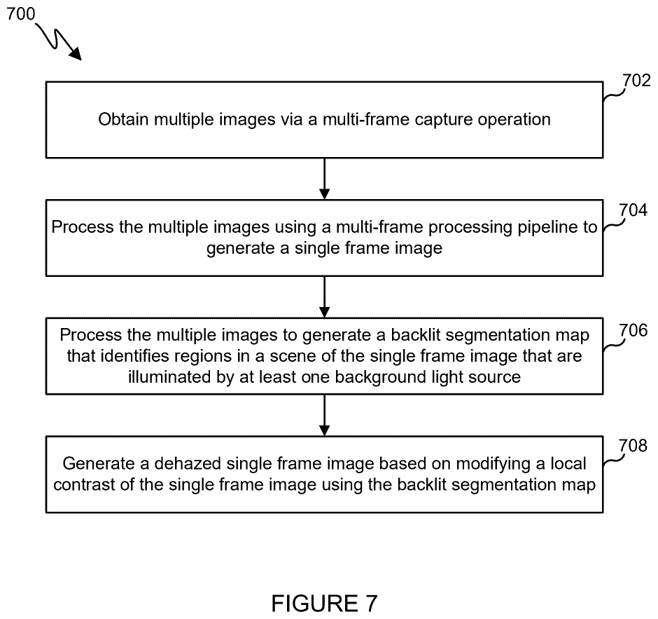

FIG. 7 illustrates an example method 700 for image haze reduction in accordance with this disclosure. For case of explanation, the method 700 is described as involving the use of the electronic device 101 in the network configuration 100 of FIG. 1. However, the method 700 may be used with any other suitable electronic device (such as the server 106) or a combination of devices (such as the electronic device 101 and the server 106) and in any other suitable system(s).

At step 702, multiple images are obtained via a multi-frame capture operation. This can include the processor controlling a camera or one or more imaging sensors to capture multiple image frames of a scene. The multiple images can be the multi-frame input 202 described in this disclosure. At step 704, the multiple images are processed using a multi-frame processing pipeline, such as using the multi-frame processing operation 204, to generate a single frame image, such as the single frame image 206.

At step 706, the multiple images are also processed to generate a backlit segmentation map (which can also be referred to as a saturation map), such as the backlit segmentation map 208. The backlit segmentation map identifies regions in a scene of the single frame image that are illuminated by at least one background light source. For example, processing the multiple images to generate the backlit segmentation map can include selecting a short frame from the multiple images, determining saturation of regions in the short frame, such as via the threshold 304, and generating the backlit segmentation map based on the saturation of the regions in the short frame.

At step 708, a dehazed single frame image is generated based on modifying a local contrast of the single frame image using the backlit segmentation map. In various embodiments, generating the dehazed single frame image can include determining a dehazing strength map, such as the dehazing strength map 412, based on weights applied to the backlit segmentation map and generating the dehazed single frame image using the dehazing strength map. This can include the processor executing the weight generation operation 414 and the dehaze operation 410 described in this disclosure.

In various embodiments, generating the dehazed single frame image can further include determining a radiance map and generating the dehazed single frame image further using transmission maps and the radiance map. This can include the processor further executing the radiance map generation operation 408 and executing the dehaze operation 410 further using the radiance map. In various embodiments, determining the dehazing strength map can include determining an initial dehazing strength map, such as dehazing strength map 412, based on the weights applied to the backlit segmentation map and modulating the initial dehazing strength map based on a semantic segmentation map, such as the semantic segmentation map 502, obtained based on the single frame image, where the modulating produces the dehazing strength map, such as the dehazing strength map 506. This can include the processor executing the face and background strength modulation operation 504.

In various embodiments, modulating the initial dehazing strength map can include increasing a strength of areas in the single frame image associated with an object or a person of interest and decreasing a strength of areas in the single frame image unassociated with the object or the person of interest.

In various embodiments, generating the dehazed single frame image can further include generating a dark channel prior image based on the single frame image, performing a morphological refinement operation on the dark channel prior image to generate a first transmission map, performing a guided filter operation on the first transmission map to generate a second transmission map, determining the radiance map based on the second transmission map, generating a third transmission map based on the second transmission map and the dehazing strength map, and generating the dehazed single frame image based on the third transmission map and the radiance map. This can include the processor executing the dark channel prior generation operation 402, the morphological refinement operation 404, the guided filter refinement operation 406, the radiance map generation operation 408, and the dehaze operation 410, as described in this disclosure.

Although FIG. 7 illustrates one example of a method 700 for 700 for image haze reduction, various changes may be made to FIG. 7. For example, while shown as a series of steps, various steps in FIG. 7 could overlap, occur in parallel, occur in a different order, or occur any number of times (including zero times).

It should be noted that the functions or operations shown in FIGS. 2 through 7 or described above can be implemented in an electronic device 101, 102, 104, server 106, or other device(s) in any suitable manner. For example, in some embodiments, at least some of the functions or operations shown in FIGS. 2 through 7 or described above can be implemented or supported using one or more software applications or other software instructions that are executed by the processor 120 of the electronic device 101, 102, 104, server 106, or other device(s). In other embodiments, at least some of the functions or operations shown in FIGS. 2 through 7 or described above can be implemented or supported using dedicated hardware components. In general, the functions or operations shown in FIGS. 2 through 7 or described above can be performed using any suitable hardware or any suitable combination of hardware and software/firmware instructions. Also, the functions or operations shown in FIGS. 2 through 7 or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining multiple images via a multi-frame capture operation;
processing the multiple images using a multi-frame processing pipeline to generate a single frame image;
processing the multiple images to generate a backlit segmentation map that identifies regions in a scene of the single frame image that are illuminated by at least one background light source; and
generating a dehazed single frame image based on modifying a local contrast of the single frame image using the backlit segmentation map.

2. The method of claim 1, wherein processing the multiple images to generate the backlit segmentation map includes:
selecting a short frame from the multiple images;
determining saturation of regions in the short frame; and
generating the backlit segmentation map based on the saturation of the regions in the short frame.

3. The method of claim 1, wherein generating the dehazed single frame image includes:
determining a dehazing strength map based on weights applied to the backlit segmentation map; and
generating the dehazed single frame image using the dehazing strength map.

4. The method of claim 3, wherein generating the dehazed single frame image further includes:
determining a radiance map; and
generating the dehazed single frame image further using transmission maps and the radiance map.

5. The method of claim 4, wherein determining the dehazing strength map includes:
determining an initial dehazing strength map based on the weights applied to the backlit segmentation map; and
modulating the initial dehazing strength map based on a semantic segmentation map obtained based on the single frame image, wherein the modulating produces the dehazing strength map.

6. The method of claim 5, wherein modulating the initial dehazing strength map includes:
increasing a strength of areas in the single frame image associated with an object or a person of interest; and
decreasing a strength of areas in the single frame image unassociated with the object or the person of interest.

7. The method of claim 4, wherein generating the dehazed single frame image further includes:
generating a dark channel prior image based on the single frame image;
performing a morphological refinement operation on the dark channel prior image to generate a first transmission map;
performing a guided filter operation on the first transmission map to generate a second transmission map;
determining the radiance map based on the second transmission map;
generating a third transmission map based on the second transmission map and the dehazing strength map; and
generating the dehazed single frame image based on the third transmission map and the radiance map.

8. An electronic device comprising:
at least one processing device configured to:
obtain multiple images via a multi-frame capture operation;
process the multiple images using a multi-frame processing pipeline to generate a single frame image;
process the multiple images to generate a backlit segmentation map that identifies regions in a scene of the single frame image that are illuminated by at least one background light source; and
generate a dehazed single frame image based on modifying a local contrast of the single frame image using the backlit segmentation map.

9. The electronic device of claim 8, wherein, to process the multiple images to generate the backlit segmentation map, the at least one processing device is further configured to:
select a short frame from the multiple images;
determine saturation of regions in the short frame; and
generate the backlit segmentation map based on the saturation of the regions in the short frame.

10. The electronic device of claim 8, wherein, to generate the dehazed single frame image, the at least one processing device is further configured to:
determine a dehazing strength map based on weights applied to the backlit segmentation map; and
generate the dehazed single frame image using the dehazing strength map.

11. The electronic device of claim 10, wherein, to generate the dehazed single frame image, the at least one processing device is further configured to:
determine a radiance map; and
generate the dehazed single frame image further using transmission maps and the radiance map.

12. The electronic device of claim 11, wherein, to determine the dehazing strength map, the at least one processing device is further configured to:
determine an initial dehazing strength map based on the weights applied to the backlit segmentation map; and
modulate the initial dehazing strength map based on a semantic segmentation map obtained based on the single frame image, wherein the modulating produces the dehazing strength map.

13. The electronic device of claim 12, wherein, to modulate the initial dehazing strength map, the at least one processing device is further configured to:
increase a strength of areas in the single frame image associated with an object or a person of interest; and
decrease a strength of areas in the single frame image unassociated with the object or the person of interest.

14. The electronic device of claim 11, wherein, to generate the dehazed single frame image, the at least one processing device is further configured to:
generate a dark channel prior image based on the single frame image;
perform a morphological refinement operation on the dark channel prior image to generate a first transmission map;
perform a guided filter operation on the first transmission map to generate a second transmission map;
determine the radiance map based on the second transmission map;
generate a third transmission map based on the second transmission map and the dehazing strength map; and
generate the dehazed single frame image based on the third transmission map and the radiance map.

15. A non-transitory machine readable medium comprising instructions that when executed cause at least one processor of an electronic device to:
obtain multiple images via a multi-frame capture operation;
process the multiple images using a multi-frame processing pipeline to generate a single frame image;
process the multiple images to generate a backlit segmentation map that identifies regions in a scene of the single frame image that are illuminated by at least one background light source; and
generate a dehazed single frame image based on modifying a local contrast of the single frame image using the backlit segmentation map.

16. The non-transitory machine readable medium of claim 15, wherein the instructions that when executed cause the at least one processor of the electronic device to process the multiple images to generate the backlit segmentation map further include instructions that when executed cause the at least one processor of the electronic device to:
select a short frame from the multiple images;
determine saturation of regions in the short frame; and
generate the backlit segmentation map based on the saturation of the regions in the short frame.

17. The non-transitory machine readable medium of claim 15, wherein the instructions that when executed cause the at least one processor of the electronic device to generate the dehazed single frame image further include instructions that when executed cause the at least one processor of the electronic device to:
determine a dehazing strength map based on weights applied to the backlit segmentation map; and
generate the dehazed single frame image using the dehazing strength map.

18. The non-transitory machine readable medium of claim 17, wherein the instructions that when executed cause the at least one processor of the electronic device to generate the dehazed single frame image further include instructions that when executed cause the at least one processor of the electronic device to:
determine a radiance map; and
generate the dehazed single frame image further using transmission maps and the radiance map.

19. The non-transitory machine readable medium of claim 18, wherein the instructions that when executed cause the at least one processor of the electronic device to determine the dehazing strength map, further include instructions that when executed cause the at least one processor of the electronic device to:
determine an initial dehazing strength map based on the weights applied to the backlit segmentation map; and
modulate the initial dehazing strength map based on a semantic segmentation map obtained based on the single frame image, wherein the modulating produces the dehazing strength map.

20. The non-transitory machine readable medium of claim 18, wherein the instructions that when executed cause the at least one processor of the electronic device to generate the dehazed single frame image, further include instructions that when executed cause the at least one processor of the electronic device to:
generate a dark channel prior image based on the single frame image;
perform a morphological refinement operation on the dark channel prior image to generate a first transmission map;
perform a guided filter operation on the first transmission map to generate a second transmission map;
determine the radiance map based on the second transmission map;
generate a third transmission map based on the second transmission map and the dehazing strength map; and
generate the dehazed single frame image based on the third transmission map and the radiance map.
